(19) United States
(12) Patent Application Publication
(10) Pub. No.: US 2017/0302147 A1
(43) Pub. Date: Oct. 19, 2017

(54) Electric motor and generator

(71) Applicant: Paul Boaventura-Delanoe, Van Nuys, CA (US)

(72) Inventors: Paul Boaventura-Delanoe, Van Nuys, CA (US); David R. Squires, Van Nuys, CA (US)

(21) Appl. No.: 15/731,074

(22) Filed: Apr. 14, 2017

Related U.S. Application Data
(63) Continuation-in-part of application No. 15/099,567, filed on Apr. 14, 2016.

(51) Int. Cl. H02K 47/18; H02K 53/00

(52) U.S. Cl. CPC H02K 47/18; H02K 53/00; Y10S 74/09

(57) ABSTRACT

The invention provides a high torque, high efficiency switched reluctance motor and method for generating electricity or mechanical energy with reduced CEMF resistance. The motor includes a rotor having a plurality of rotor poles, stators positioned around the rotor having a plurality of bifurcated stator poles, coil windings located in the separation between the legs of each stator pole, magnets mounted between adjacent stator poles, a shunt in electromagnetic communication with the coil windings and the stator poles, and a bridge component encircled by the coil windings and separating each stator pole from each shunt.

### CROSS-REFERENCE TO RELATED APPLICATIONS

This application is a continuation-in-part and claims the benefit of and priority to U.S. patent application Ser. No. 15/099567, filed Apr. 14, 2016, the entirety of which is hereby incorporated herein by specific reference for all purposes.

### FIELD OF THE INVENTION

The present disclosure is directed to an electric motor which can also function as a generator producing electricity, and more particularly a high torque switched reluctance motor configured to maximally saturate the motor core and increase torque.

### BACKGROUND OF THE INVENTION

There is an ongoing need to efficiently produce electricity without the use of fossil fuels to produce clean, green electricity which can be consumed on site, or fed into an electricity grid to be distributed to other users.

Other methods of producing electricity use fossil fuels which are damaging to the environment or have very harmful byproducts such as CO₂, spent nuclear fuel rods, coal ash, and other byproducts.

Typically, an electric motor takes power in the form of voltage and current. This power is converted over time into mechanical energy, for example in the form of rotation of a shaft attached to the motor to operate another device, such as a generator. Switched reluctance motors are well-known in the art. One type of reluctance motor is controlled by circuitry that determines the position of the rotor, and coil windings on the stator poles are energized as a function of rotor position. This type of reluctance motor is generally referred to as a “switched reluctance motor” or “SRM.” Rotors are typically constructed of low reluctance materials such as iron and its alloys, nickel, cobalt, etc., that tend to strongly align to an incident magnetic field. Thus, a typical SRM has a rotor with alternating regions of high and low reluctance on it, and a stator with electromagnets, that when energized in sequence, will pull the low reluctance regions, or poles of the rotor, to turn the rotor and produce power.

The number of stator poles and the number of rotor poles in a SRM may be varied resulting in many different geometries. A common geometry is a 6 stator 4 rotor configuration (“6 4 SRM”), with the rotor concentric to the stator and rotably positioned relative to the stator. The stator and rotor consist of salient (projecting) poles, with wire coils wound around a portion of each stator. The wire coils receive electricity from an outside source. A shaft is typically positioned centrally of the stator and rotor, coupled to the center of the rotor, to transfer the driving force of the motor to mechanical energy, for example, another device.

When current is supplied to coil windings in a motor in a magnetic field, the magnetic force generated, the flux, produces a torque which causes the rotor to turn relative to the stator, or the stator to turn relative to the rotor, producing magnetic flux changes. An electromotive force (EMF), consistent with Faraday's law of induction, is induced in the coil windings, moving the rotor poles towards the stator poles, so as to minimize resistance. The induced EMF opposes any change, so that the input EMF that powers the motor will be opposed by the motor's self-generated EMF, called the “back” or “counter” EMF (CEMF) of the motor. The presence of CEMF will result in lower efficiency and a need for increased voltage across the coils to overcome the CEMF. If the rotor or stator is rotating slowly, the CEMF is relatively low, and a large current flows through the motor, providing a high torque. As the speed of rotation of the motor increases, the CEMF increases, reducing the current through the motor. The CEMF determines the speed of the motor for a particular voltage, such that the speed of motors is controlled by varying the supplied voltage. More torque loading will result in less speed and more current. As the load on the motor increases, the motor will slow, reducing the CEMF and permitting a larger current to flow in the coils. By reducing CEMF resistance, a motor can operate at significantly increased efficiencies.

Variations of a switched reluctance motor are known, for example, where permanent magnets are located between adjacent stators of a conventional switched reluctance motor or on the rotors, or on both. Certain of these variations are referred to as “hybrid switched reluctance motors.”

There remains a need for hybrid high torque switched reluctance motors that can operate at increased efficiencies to operate devices/to operate as a device, such as DC and AC electricity generator and/or to operate mechanical equipment.

### SUMMARY OF THE INVENTION

According to an aspect of the present disclosure, there is provided a high torque hybrid switched reluctance motor having a rotor having a plurality of rotor poles spaced equally circumferentially around the rotor core, stators surrounding the rotor and having a plurality of stator poles having bifurcated legs, a shunt in electrical communication with the stator poles and in electromagnetic communication with the coil windings and the stator poles, a bridge component in the separation between the legs of each stator pole and separating each stator pole from each shunt, coil windings encircling each bridge, and a permanent magnet positioned between adjacent stator poles, where the rotor and stators are configured to direct the magnetic coil flux and permanent magnet flux to maximally saturate the motor core and redirect the CEMF through successive coils, recycling the CEMF and resulting in reduced CEMF resistance.

Advantageously, the hybrid switched reluctance motor of the present disclosure has permanent magnets located in the rotor poles.

Advantageously, there is provided a method for generating mechanical energy comprising operating the hybrid switched reluctance motor of the present disclosure.

Advantageously, the rotor has four poles and the stator component has six stator poles, each pole having bifurcated legs, six bridge components and six shunts.

Advantageously, the hybrid switched reluctance motor of the present disclosure has at least one timing disk operably connected to the shaft of the motor to control the timing of the input and withdrawal of current to each coil winding, a controller in communication with the timing disk to control movement of the disk, and a timing disk sensor to detect movement of the timing disk and to provide instructions to the controller to turn on and off the electrical current to the coil windings.

Additional features, advantages, and aspects of the present disclosure are set forth or apparent from consideration of the following detailed description, drawings, and claims. Moreover, it is to be understood that both the foregoing summary of the present disclosure and the following detailed description are exemplary and intended to provide further explanation without limiting the scope of the present disclosure as claimed. No attempt is made to show structural details of the present disclosure in more detail than may be necessary for a fundamental understanding of the present disclosure and the various ways in which it may be practiced.

### BRIEF DESCRIPTION OF THE DRAWINGS

The accompanying drawings, which are included to provide a further understanding of the present disclosure, are incorporated in and constitute a part of this specification, illustrate aspects of the present disclosure and together with the detailed description serve to explain the principles of the present disclosure. No attempt is made to show structural details of the present disclosure in more detail than may be necessary for a fundamental understanding of the present disclosure and the various ways in which it may be practiced. In the drawings:

FIG. 1 illustrates an implementation of the hybrid high torque switched reluctance motor of the invention.

FIG. 2 shows the motor assembly of the switched reluctance motor having end caps and in a housing, in an implementation of the invention.

FIG. 3 depicts an angled side view of the timing disk on an end cap of the motor, in an implementation of the invention.

### DETAILED DESCRIPTION OF THE INVENTION

The aspects of the present disclosure and the various features and advantageous details thereof are explained more fully with reference to the non-limiting aspects and examples that are described and/or illustrated in the accompanying drawings and detailed in the following description. It should be noted that the features illustrated in the drawings are not necessarily drawn to scale, and features of one aspect may be employed with other aspects as the skilled artisan would recognize, even if not explicitly stated herein. Descriptions of well-known components and processing techniques may be omitted so as to not unnecessarily obscure the aspects of the present disclosure. The examples used herein are intended merely to facilitate an understanding of ways in which the present disclosure may be practiced and to further enable those of skill in the art to practice the aspects of the present disclosure. Accordingly, the examples and aspects herein should not be construed as limiting the scope of the present disclosure, which is defined solely by the appended claims and applicable law. Moreover, it is noted that like reference numerals represent similar parts throughout the drawings.

In an implementation of the invention, the hybrid switched reluctance electric motor having high torque and reduced/recycled counter electromotive force, includes a rotor component having a plurality of rotor poles spaced equally circumferentially around the center of the rotor component, a stator component positioned around the rotor component and having a plurality of bifurcated stator poles having legs and coil windings located in the separation between the legs of each stator pole, and permanent magnets mounted between adjacent stator poles, a shunt in electromagnetic communication with the coil windings and the stator poles and a bridge component encircled by the coil windings and separating each stator pole from each shunt. The motor may include a rotor having four poles and the stator component may have six stator poles, six bridge components and six shunts.

Permanent magnets, such as rare earth metals, for example neodymium magnets, are placed between the legs of each adjacent stator to create a permanent magnet flux that is combined with the magnetic coil flux, created when current is passed to the coil, and to control its directional flow, creating maximum saturation of the motor core, which includes the rotor, and stator laminations, as quickly as possible. Additional permanent magnets may be positioned in the rotor to increase the size of the magnetic field in the rotor.

In an implementation of the motor, the rotor and stator are made of electrical steel laminations. The laminations are designed to increase the surface area of the magnetic field. The electric flux through an area is defined as the electric field multiplied by the area of the surface projected in a plane perpendicular to the field. Gauss's Law is a general law applying to any closed surface. By combining the permanent magnet flux with the magnetic coil flux and directing the path of the dual magnetic fluxes, the maximum saturation of the laminations of the stator and rotor is achieved faster, which increases the torque of the motor.

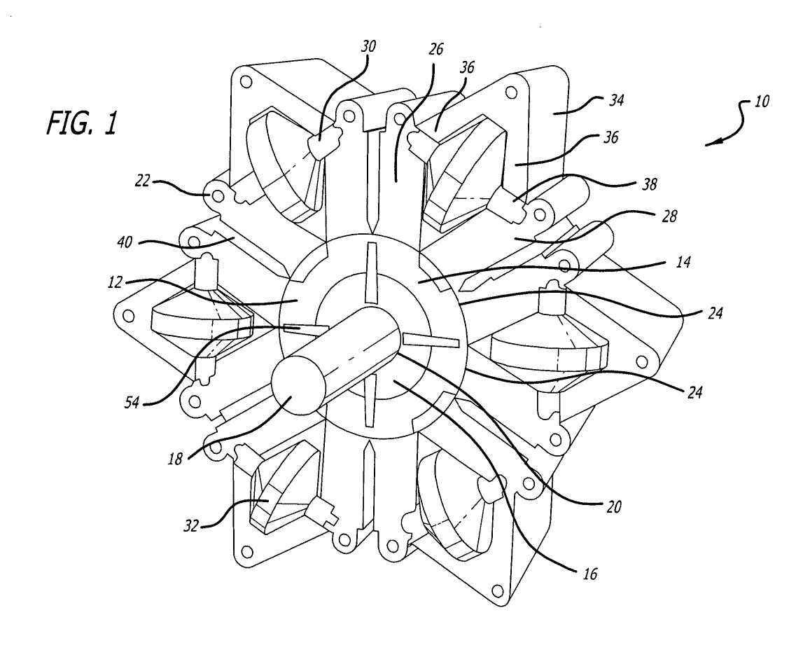

The magnetic flux in any motor will take the path of least resistance. The structure of the motor of the invention, as depicted in FIGS. 1 through 3, and described in more detail below, and in particular the placement of each stator, coil and magnet relative to the other components of the motor, permits the direction of the combined magnetic coil flux and permanent magnet flux to be controlled and the torque greatly enhanced. When electricity from an outside source is sent to a stator coil, the magnetic coil flux travels down one arm of the stator into the rotor. It cannot travel down the opposite arm because the 4 pole design of the rotor leaves an open path down the opposing stator arm into the rotor. As the magnetic coil flux travels down the stator arm it passes by the permanent magnet that is positioned between each stator. The permanent magnet flux is combined with the magnetic coil flux to create a ‘dual flux’ that causes the motor core to reach maximum saturation faster. The faster the motor core reaches saturation the more torque is created in the motor.

Referring to Table 1, when the current to the coil is turned off (Point a at top of the curve) the CEMF will attempt to return to the point of origin (Table 1, Point d at the bottom of the curve). By controlling the path of the CEMF, the CEMF can be redirected from the originating coil down the H axis to the adjacent coil in the series. This greatly reduces the resistance and heat losses in the coil and increases the efficiencies of the motor. The CEMF is thus recycled, for example as voltage to supply current to the next coil in the series, reducing the CEMF resistance. The energy in the CEMF cannot be created or destroyed, but with strong enough magnets and a closed path, the CEMF can be redirected to the adjacent coils. The CEMF may also be removed from each stator and stored.

In another implementation, a method of providing mechanical energy includes providing electrical current to the coil windings of the motor of the invention, where the motor includes a rotor component having a plurality of rotor poles spaced equally circumferentially around the center of the rotor component, a stator component positioned around the rotor component and having a plurality of bifurcated stator poles having legs and coil windings located in the separation between the legs of each stator pole, and a permanent magnet mounted between adjacent stator poles, a shunt in electromagnetic communication with the coil windings and the stator poles, and a bridge component encircled by the coil windings and separating each stator pole from each shunt.

According to an aspect of the present disclosure, referring to FIG. 1, an implementation of the motor 10 of the invention is a hybrid high torque switched reluctance motor, that operates at a selected speed (rpm), without surges or power drains. The motor 10 reduces the counter electromotive force (CEMF) resistance by maximally saturating the motor coils and optimally at high motor loads, requiring less energy to operate the motor, without surges or power drains. The motor may consist of four rotors and six stators, or other combinations.

According to the present disclosure, referring to FIG. 1, an implementation of the motor 10 of the invention includes a rotor 12 that may have four (4) salient rotor poles 14 positioned equally spaced circumferentially around rotor component 12, which may have central core 16, and may have shaft 18, inserted into an opening 20 of the rotor 12. The motor 10 further includes a stator component 22 that may have six (6) adjacent, bifurcated salient stator poles 24, each stator pole 24 having a first leg 26 and a second leg 28. The salient stator poles 24 are not in contact at their bases with the rotor component 12. In an implementation, rotor poles 14 cover 60 degrees of the 360-degree arc of the rotor component 12. The motor 10 may include other numbers of rotor poles 14 and stator poles 24, for example eight rotor poles 14 and twelve stator poles 24, or twelve rotor poles 14 and eighteen stator poles 24. The rotor component 12, stator component 22 and shaft 18 may be formed of low carbon steel, electrosteel, lamination steel or other suitable material, for example as multiple layers or thin “stacks.” The rotor 12 may be made of electrical steel laminations, or may be made of other suitable material.

As also shown in FIG. 1, each pair of bifurcated stator poles 24 has a bridge 30, that connects the legs 26 and 28 of each stator pole 24 and support the coil windings 32. The bridges 30 serve to redirect the magnet flux across the stator poles 24 and reduce the CEMF resistance. Coil windings 32 may be wound around and encircle each bridge 30. Optimally, each coil consists of multiple turns of wire. Coil windings 32 may be made of copper or other conducting metal such as aluminum. Each bifurcated stator pole 24 further has a shunt 34 having two legs 36. In an implementation illustrated in FIG. 1, the shunt 34, the first 36 and second 38 legs separated by a gap 38 from the bridge 30. A non-conducting shim (not shown) may be inserted between the bridge 30 and each shunt leg 36 of each stator pole 24. The shunt 34 can be other shapes such as a square, rectangle or round. Permanent magnets 40 are positioned between the legs of adjacent stator poles 24 and serve to direct the magnet flux between the magnets 40. The stator 22, bridges 30, coils 32 and shunt 34 are collectively referred to as the stator assembly 42.

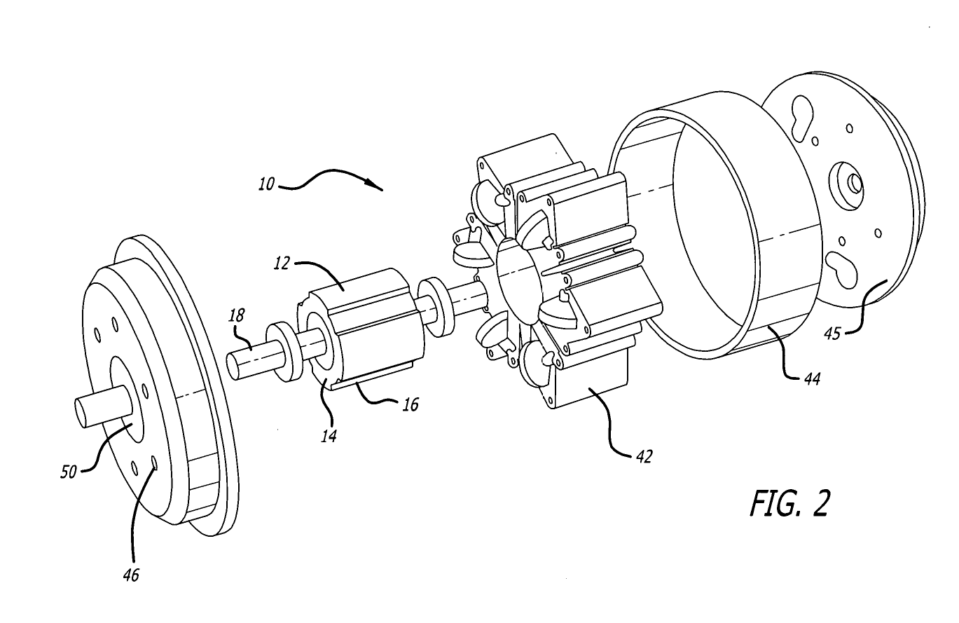

As shown in FIG. 2, the rotor 12 and stator assembly 42 may be assembled and placed in housing 44 with end caps 45 and 46 to comprise motor 10. Shaft 18 may be connected to any device (not shown) that requires application of mechanical energy, such as a generator. Permanent magnets 54 may be located in the rotor poles 14.

When electrical current is provided to coil windings 32 of opposite stators, a magnetic coil flux is created and together with the permanent magnet flux causes the rotor 12 to rotate within stator assembly 42 a selected distance across the stator poles, generating a magnet flux from magnets 40, which is combined with the coil magnetic flux to create greater torque. When energized with an opposing polarity, the magnetic field is forced into the rotor 12 to create maximum torque. In a 4 rotor pole 14, 6 stator pole 24 motor, when one pair of opposite rotor poles 14 has moved into alignment with both legs of a stator pole 24, the other pair of opposite rotor poles 14 is in alignment with the second leg 28 of one stator pole 24 and the first leg 26 of the adjacent stator pole 24 for the next torque cycle. When there is no electrical current provided to the coils 32, the magnetic field of the coil flows around the perimeter of the stator assembly 42 and not into the rotor 12. However, the CEMF will attempt to flow from the rotor into the coil of the aligned, opposing stator poles. However, the CEMF will be redirected into the next progressive stator, because the bridge 30 between the two stator legs 26 and 28 creates a closed path, and with the assistance of the magnets between adjacent stator legs, is redirected.

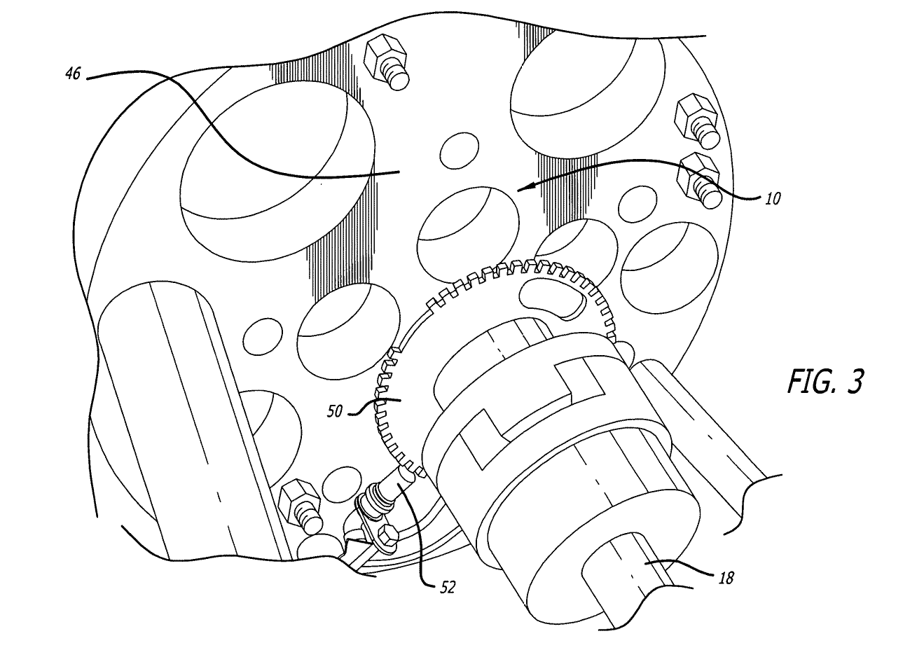

In one implementation of the invention, as shown in FIG. 3, a CPU controller 48 (not shown) programmed with software, a toothed timing disk 50 and sensor 52 may be used to set the timing of power supply to the coil windings 32. Timing disk 50 may be positioned on either end cap 46 or 45 of the motor (FIG. 3). For example, a controller 48 programmed with software operates timing disk 50 which is attached to the shaft 18 of motor 10 on either side of the motor, and is “read” by sensor 52 to turn on (allow electrical current to flow into) the coil windings 32, turning the power off (stopping the current), before a leg of a stator pole 24 comes into alignment with a rotor pole 14. As the timing disk 50 rotates, the teeth pass in front of timing sensor 52. The sensor 52 triggers the controller 48 to turn the electrical current on or off in the appropriate coil winding. The fluxes resulting from alternatively switching the current to the coil winding 32 on and off results in turning of the rotor 12 and turning of the shaft 18, transferring mechanical energy. In an implementation, the timing disk 50 is calibrated to cause revolutions of the motor shaft 18 of at a selected speed (rpm). Timing disks, sensors and controllers are known. Suitable timing disks and controllers are the 60-2 toothed trigger wheel and Redline controller available from Pantera EFI, Santa Ana, Calif. (www. panteraEFI.com). Suitable sensors include magnetic gear tooth sensors (Sensor Solutions, Steamboat Springs, Colo., www.sensorso.com) or other sensors, such as optical sensors known in the art.

The use of shunts 34 causes the coil windings 32 to become maximally saturated which prevents large changes in the magnetic field inside the coil windings 32, reducing the amount of CEMF resistance and, in turn, reducing the amount of electrical power needed to operate the motor. Additionally, the permanent magnets are used to redirect the CEMF to the next permanent magnet in rotation through the bridge where it is combined with the magnet flux and coil flux in the next stator pole. Because the shunts, stators and bridge are fully saturated, this results in improvement in power conversion efficiency (electrical to mechanical gain) and reduced CEMF resistance. In addition, electrical current can be recycled from flux relaxation in the coils resulting in further power gain factors (coefficients of performance). Excess electrical energy is drawn from the shunts and may be stored for example in capacitors or batteries, or used to power other devices.

Thus, hybrid high torque switched reluctance motor 10 reduces CEMF resistance, while maintaining high torque under constant or changing loads. Parameters of performance of motor 10 may be adjusted, for example, a motor 10 having a desired horsepower is produced by adjusting the dimensions of the of the rotor and stator laminations, the number of coil windings and/or the dimensions of the shunt.

The motor of the invention may be used to generate rotational energy via the shaft of the motor. Alternatively, if the shaft of the motor is turned, it functions as a generator producing electricity which may be harvested.

While the present disclosure has been described in terms of exemplary aspects, those skilled in the art will recognize that the present disclosure can be practiced with modifications in the spirit and scope of the appended claims. These examples and implementations given above are merely illustrative and are not meant to be an exhaustive list of all possible designs, aspects, applications or modifications of the present disclosure. The number of rotor poles and/or stator poles of the motor may be varied, as well as the number of windings of the field coils around the shunts. Multiple high torque motors powered by a battery or other energy source, may be used to operate multiple AC or DC generators or other devices.

What is claimed is:

1. A high torque hybrid switched reluctance motor 10 comprising:
a rotor 12 having a plurality of rotor poles 14 spaced equally circumferentially around the rotor core 16;
stators 22 surrounding the rotor 12 and having a plurality of stator poles 24 having bifurcated legs (26,28);
a shunt 34 having legs 36 in electrical communication with the stator poles 24 and in electromagnetic communication with the coil windings 32 and the stator poles 24;
a bridge 30 component in the separation between the bifurcated legs (26,28) of each stator pole 24 and separating each stator pole 24 from each shunt 34;
coil windings 32 encircling each bridge 30; and
a permanent magnet 40 positioned between adjacent stator poles 24,
wherein the rotor 13 and stators 22 are configured to direct the combined magnetic coil flux and permanent magnet flux to maximally saturate the motor core and redirect the CEMF through successive coil windings 32, recycling the CEMF and resulting in reduced CEMF resistance.

2. The motor 10 of claim 1 wherein permanent magnets 54 are located in the rotor poles 14.

3. A method for generating electricity comprising operating motor 10 of claim 1.

4. A method for generating mechanical energy comprising operating motor 10 of claim 1.

5. The motor 10 of claim 1, wherein the rotor 12 has four poles 14 and the stator component 22 has six stator poles 24 each pole 24 comprising bifurcated legs (26, 28), six bridge components 30 and six shunts 34.

6. The motor 10 of claim 1, further comprising:
at least one timing disk 50 operably connected to the shaft 18 of one of end caps (45,46) of the motor 10 to control the timing of the input and withdrawal of current to each coil winding 32;
a controller 48 in communication with the timing disk to control movement of the disk; and
a timing disk sensor 52 to detect movement of the timing disk 50 and to provide instructions to the controller 48 to turn on and off the electrical current to the coil windings 32.
